(19) United States
(12) Patent Application Publication
(10) Pub. No.: US 2024/0266686 A1
(43) Pub. Date: Aug. 8, 2024

(54) BATTERY DEVICE

(71) Applicant: HONDA MOTOR CO., LTD., Tokyo (JP)

(72) Inventor: Yuya Ishihara, Wako-shi (JP)

(21) Appl. No.: 18/432,128

(22) Filed: Feb. 5, 2024

(30) Foreign Application Priority Data
Feb. 8, 2023 (JP) 2023-017353

(51) Int. Cl. H01M 50/517; H01M 10/42; H01M 50/211; H01M 50/553

(52) U.S. Cl. CPC H01M 50/517; H01M 10/425; H01M 50/211; H01M 50/553; H01M 2010/4271

(57) ABSTRACT

A battery device including a plurality of battery cells stacked in the X direction, a first tab connection portion, and the second tab connection portion, the first tab connection portion connecting a positive electrode tab of a first battery cell and a negative electrode tab of a second battery cell with each other, and the second tab connection portion connecting a positive electrode tab of a third battery cell and a negative electrode tab of a fourth battery cell with each other, wherein the first tab connection portion and the second tab connection portion are adjacent to each other in the Y direction.

### CROSS-REFERENCE TO RELATED APPLICATIONS

This application is based upon and claims the benefit of priority from Japanese Patent Application No. 2023-017353 filed on Feb. 8, 2023, the contents of which are incorporated herein by reference.

### BACKGROUND OF THE INVENTION

### Field of the Invention

The present invention relates to a battery device.

### Description of the Related Art

JP 2008-186725 A discloses a battery cell connection structure. In this battery cell connection structure, the electrode of a battery cell and the electrode of another battery cell are fastened together by screws.

### SUMMARY OF THE INVENTION

When the thickness of the battery cells is relatively thin with respect to the screws, the technique disclosed in JP 2008-186725 A has a problem that the space between the battery cells becomes wide.

An object of the present invention is to solve the aforementioned problem.

An aspect of the present invention is a battery device including a plurality of battery cells stacked in a first direction; a first tab connection portion connecting a first electrode tab and a second electrode tab with each other, the first electrode tab being provided for a first battery cell among the plurality of battery cells and the second electrode tab being provided for a second battery cell adjacent to the first battery cell among the plurality of battery cells; and a second tab connection portion connecting a third electrode tab and a fourth electrode tab with each other, the third electrode tab being provided for a third battery cell adjacent to the second battery cell among the plurality of battery cells and the fourth electrode tab being provided for a fourth battery cell adjacent to the third battery cell among the plurality of battery cells, wherein the first tab connection portion and the second tab connection portion are adjacent to each other in a second direction intersecting the first direction.

The present invention can reduce the spacing between battery cells.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a battery device;

FIG. 2 is a perspective view of a battery module;

FIG. 3 is a top view of the battery module;

FIG. 4 is a perspective view of a battery cell;

FIG. 5 is a perspective view showing a first type of battery cell;

FIG. 6 is a perspective view showing a second type of battery cell;

FIG. 7 is a perspective view showing a third type of battery cell;

FIG. 8 is a perspective view showing a fourth type of battery cell;

FIG. 9 is an enlarged perspective view of a connection portion between positive and negative electrode tabs;

FIG. 10 is a perspective view of a terminal block;

FIG. 11 is a cross-sectional view of the connection portion between the positive and negative electrode tabs;

FIG. 12 is a cross-sectional view of the connection portion between the positive and negative electrode tabs.

### DETAILED DESCRIPTION OF THE INVENTION

### Embodiment

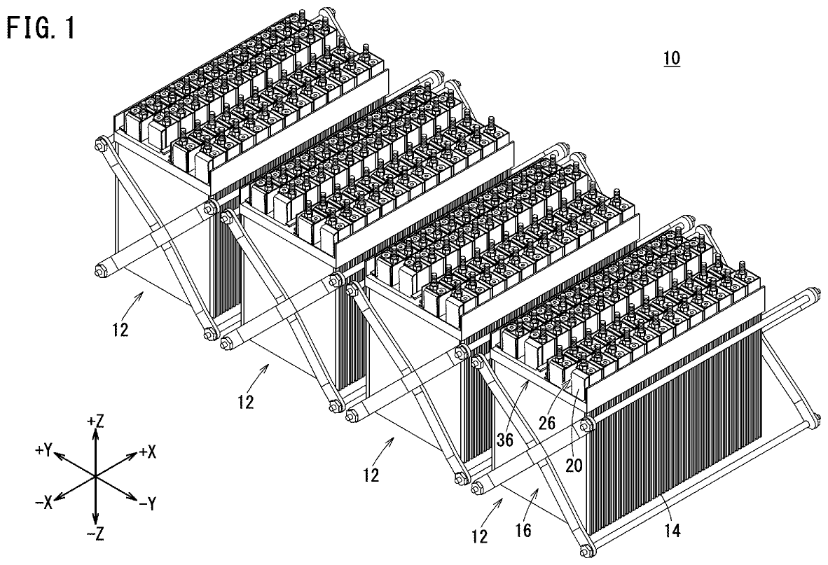

A battery device according to an embodiment is described with reference to the drawings. FIG. 1 is a perspective view of a battery device 10. In FIG. 1, arrows indicating the X, Y and Z directions are shown. The X, Y, and Z directions are perpendicular to each other. One of the X direction is defined as the +X direction and the other as the −X direction. The same is true for the Y and Z directions. The X direction corresponds to the first direction of the present invention. The Y direction corresponds to the second direction of the present invention.

The battery device 10 has four battery modules 12. The battery modules 12 are arranged in a row in the Y direction. Four battery modules 12 are connected in series.

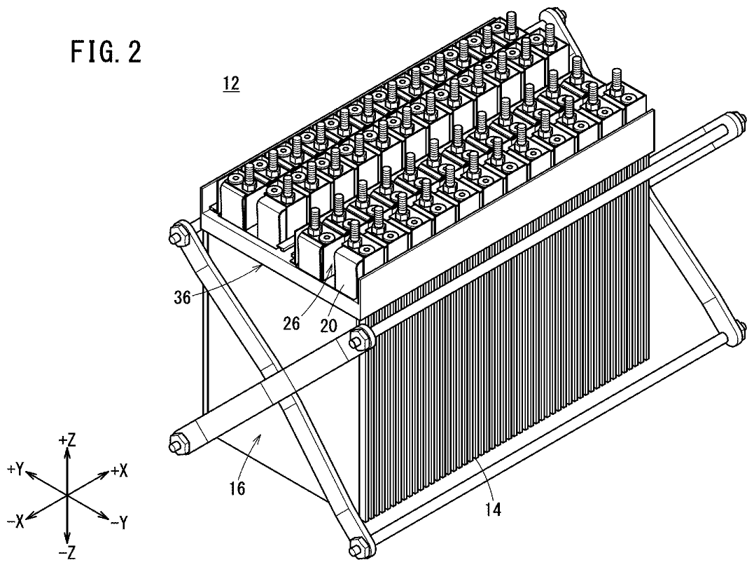

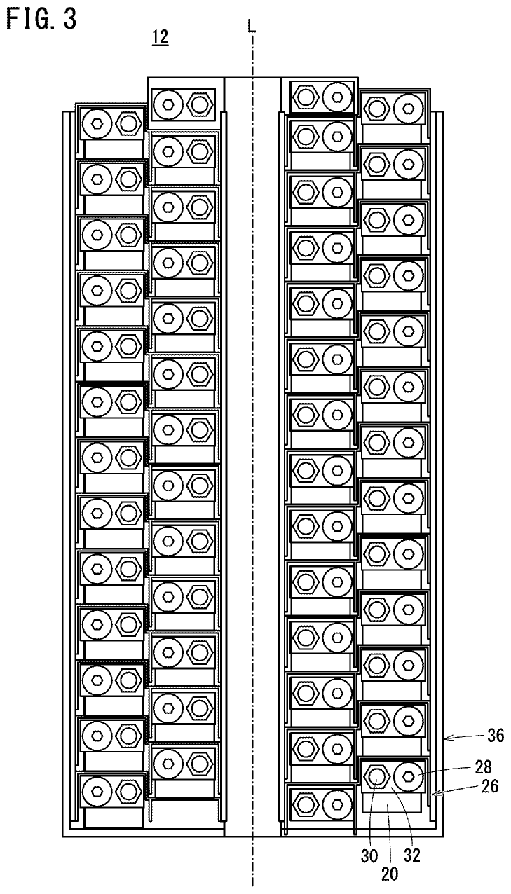

FIG. 2 is a perspective view of the battery module 12. FIG. 3 is a top view of the battery module 12. The battery module 12 has a plurality of battery cells 14 stacked in the X direction. The stacked multiple battery cells 14 are connected in series. The stacked battery cells 14 are held by a battery frame 16. The battery frame 16 applies pressure to the stacked battery cells 14 by pressing the battery cells 14 from both ends. This suppresses the expansion of the battery cell 14.

### Configuration of Battery Cells

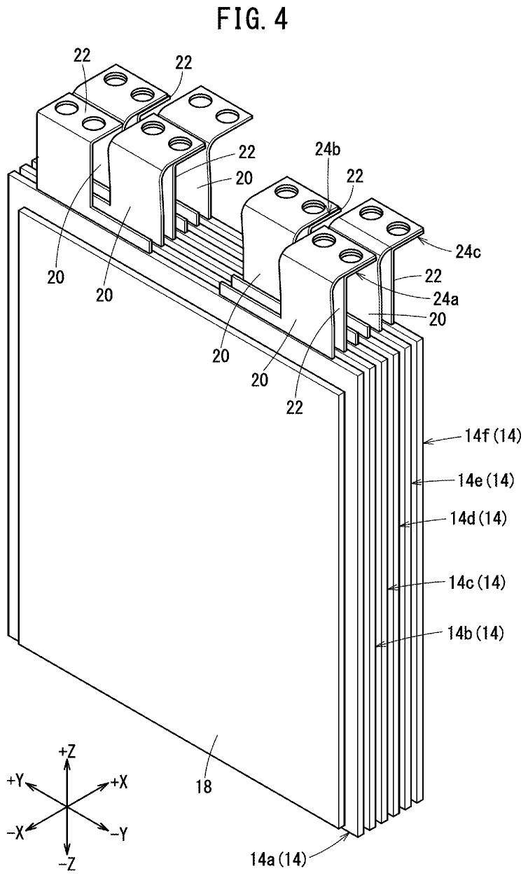

FIG. 4 is a perspective view of the battery cell 14. FIG. 4 shows six stacked battery cells 14.

The battery cell 14 is a laminated-type battery. The battery cell 14 has a body portion 18 formed in a rectangular plate shape. The battery cell 14 includes a positive electrode tab 20 and a negative electrode tab 22 formed in a plate shape. The positive electrode tab 20 and the negative electrode tab 22 protrude from the main body portion 18 in the +Z direction. The positive electrode tab 20 is formed of aluminum, and the negative electrode tab 22 is formed of copper. The positive electrode tab 20 and the negative electrode tab 22 are bent in the +X direction.

In the following, the battery cell 14 located most in the −X direction in FIG. 4 may be referred to as first battery cell 14a. The battery cell 14 adjacent to the first battery cell 14a may be referred to as second battery cell 14b. The battery cell 14 adjacent to the second battery cell 14b may be referred to as third battery cell 14c. The battery cell 14 adjacent to the third battery cell 14c may be described as fourth battery cell 14d. The battery cell 14 adjacent to the fourth battery cell 14d may be referred to as fifth battery cell 14e. The battery cell 14 adjacent to the fifth battery cell 14e may be referred to as sixth battery cell 14f.

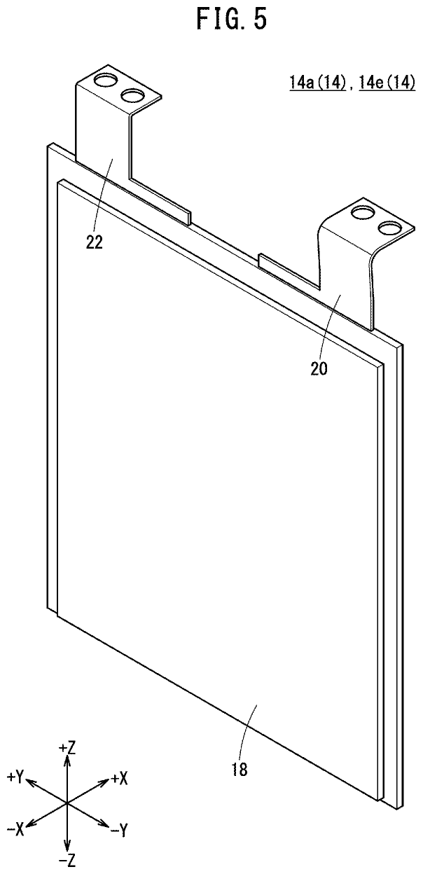

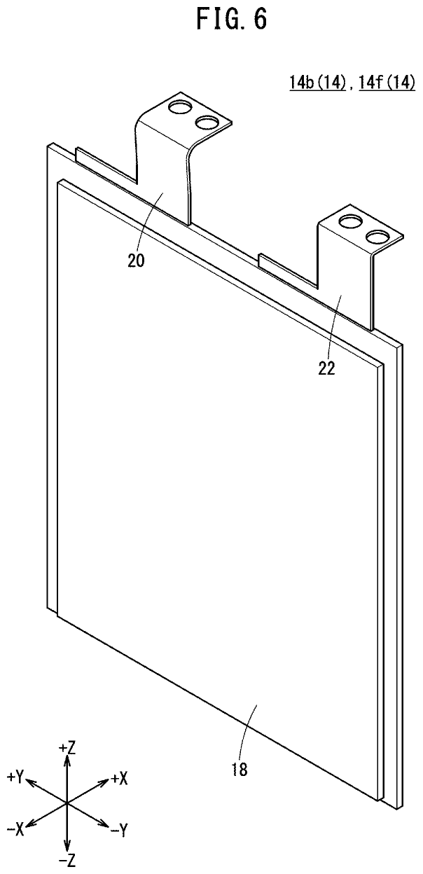

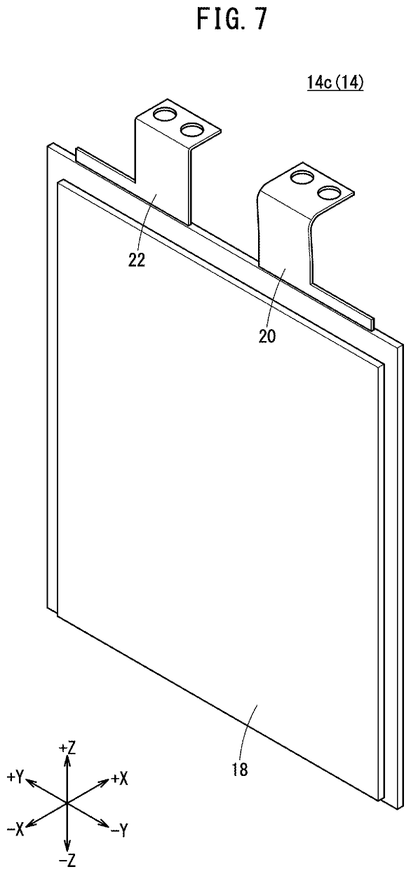

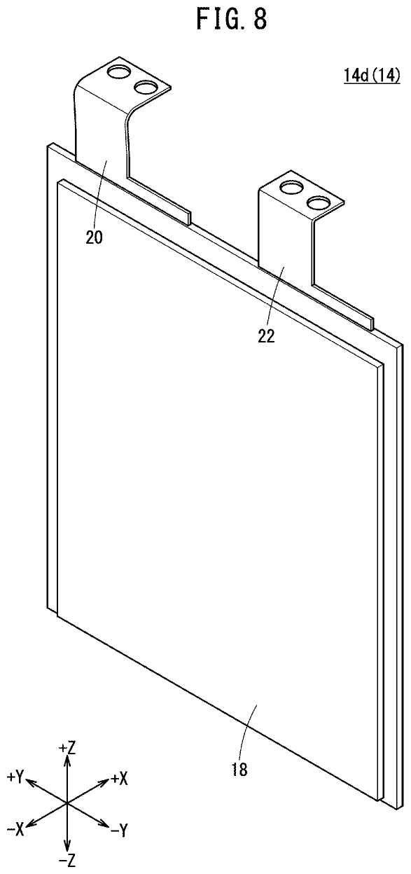

There are four types of battery cells 14 differing in the shapes of the positive electrode tab 20 and the negative electrode tab 22. FIG. 5 is a perspective view showing a first type of battery cell 14. FIG. 6 is a perspective view showing a second type of battery cell 14. FIG. 7 is a perspective view showing a third type of battery cell 14. FIG. 8 is a perspective view showing a fourth type of battery cell 14.

The first battery cell 14a and the fifth battery cell 14e are the first type of battery cells 14. The second battery cell 14b and the sixth battery cell 14f are the second type of battery cell 14. The third battery cell 14c is the third type of battery cell 14. The fourth battery cell 14d is the fourth type of battery cell 14.

As shown in FIG. 5, in the case of the first type of battery cell 14, the positive electrode tab 20 is located on an outer side and the negative electrode tab 22 is located on an outer side in the width direction of the battery cell 14. As shown in FIG. 6, in the case of the second type of battery cell 14, the positive electrode tab 20 is located on an inner side and the negative electrode tab 22 is located on an outer side in the width direction of the battery cell 14. As shown in FIG. 7, in the case of the third type of battery cell 14, the positive electrode tab 20 is located on an inner side and the negative electrode tab 22 is located on an inner side in the width direction of the battery cell 14. As shown in FIG. 8, in the case of the fourth battery cell 14d, the positive electrode tab 20 is located on an outer side and the negative electrode tab 22 is located on an inner side in the width direction of the battery cell 14.

The positive electrode tab 20 of one battery cell 14 and the negative electrode tab 22 of another battery cell 14 adjacent to the one battery cell 14 are overlapped in the Z direction and joined. Specifically, the positive electrode tab 20 of the first battery cell 14a and the negative electrode tab 22 of the second battery cell 14b are joined. The positive electrode tab 20 of the second battery cell 14b and the negative electrode tab 22 of the third battery cell 14c are joined. The positive electrode tab 20 of the third battery cell 14c and the negative electrode tab 22 of the fourth battery cell 14d are joined. The positive electrode tab 20 of the fourth battery cell 14d and the negative electrode tab 22 of the fifth battery cell 14e are joined. The positive electrode tab 20 of the fifth battery cell 14e and the negative electrode tab 22 of the sixth battery cell 14f are joined.

The positive electrode tab 20 of the first battery cell 14a corresponds to the first electrode tab of the present invention. The negative electrode tab 22 of the second battery cell 14b corresponds to the second electrode tab of the present invention. The positive electrode tab 20 of the third battery cell 14c corresponds to the third electrode tab of the present invention. The negative electrode tab 22 of the fourth battery cell 14d corresponds to the fourth electrode tab of the present invention. The positive electrode tab 20 of the fifth battery cell 14e corresponds to the fifth electrode tab of the present invention. The negative electrode tab 22 of the sixth battery cell 14f corresponds to the sixth electrode tab of the present invention.

As shown in FIG. 4, a first tab connection portion 24a and a second tab connection portion 24b are adjacent to each other in the Y direction. At the first tab connection portion 24a, the positive electrode tab 20 of the first battery cell 14a and the negative electrode tab 22 of the second battery cell 14b are connected to each other. At the second tab connection portion 24b, the positive electrode tab 20 of the third battery cell 14c and the negative electrode tab 22 of the fourth battery cell 14d are connected to each other.

The second tab connection portion 24b and a third tab connection portion 24c are adjacent to each other in the Y direction. Furthermore, the first tab connection portion 24a and the third tab connection portion 24c are adjacent to each other in the X direction. At the third tab connection portion 24c, the positive electrode tab 20 of the fifth battery cell 14e and the negative electrode tab 22 of the sixth battery cell 14f are connected to each other.

That is, as shown in FIG. 4, the first tab connection portion 24a where the positive electrode tab 20 of the first battery cell 14a and the negative electrode tab 22 of the second battery cell 14b are connected and the second tab connection portion 24b where the positive electrode tab 20 of the third battery cell 14c and the negative electrode tab 22 of the fourth battery cell 14d are connected do not overlap in the X-direction view. Therefore, even if the X-direction length of the first tab connection portion 24a is secured, the first tab connection portion 24a does not interfere with the second tab connection portion 24b.

Similarly, as shown in FIG. 4, the second tab connection portion 24b where the positive electrode tab 20 of the third battery cell 14c and the negative electrode tab 22 of the fourth battery cell 14d are connected and the third tab connection portion 24c where the positive electrode tab 20 of the fifth battery cell 14e and the negative electrode tab 22 of the sixth battery cell 14f are connected do not overlap in the X-direction view. Therefore, even if the X-direction length of the second tab connection portion 24b is secured, the second tab connection portion 24b does not interfere with the third tab connection portion 24c.

The battery module 12 is formed by repeatedly arranging the battery cells 14 in the order of first type, second type, third type, fourth type, and first type.

Although hidden by a tab plate 32 described later, the connection portion between the positive electrode tab 20 and the negative electrode tab 22 is located at the position of the tab plate 32 in FIG. 3. That is, on one side of the center line L, two rows of connection portion s between the positive electrode tab 20 and the negative electrode tab 22 are arranged in the X direction. On the other side of the center line L, two rows of connection portion s between the positive electrode tab 20 and the negative electrode tab 22 are arranged in the X direction. The center line L corresponds to a line connecting the centers in the width direction of the stacked battery cells 14.

### Connection Between Positive Electrode Tab and Negative Electrode Tab

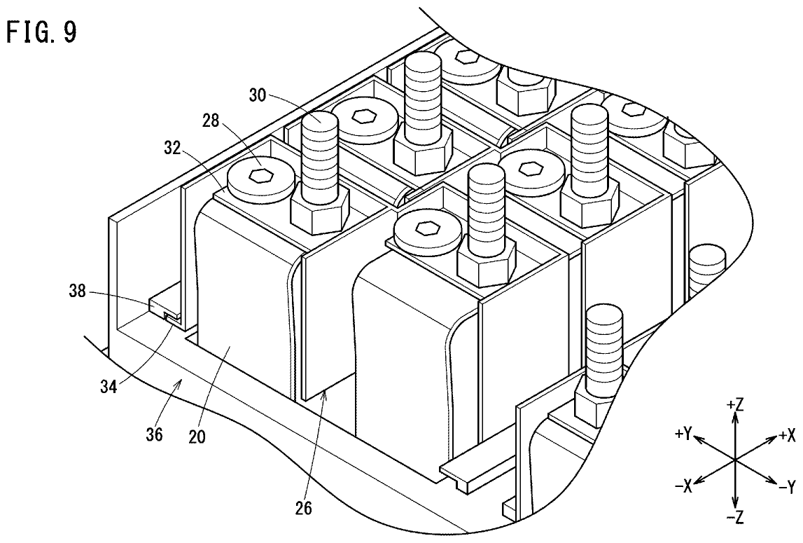

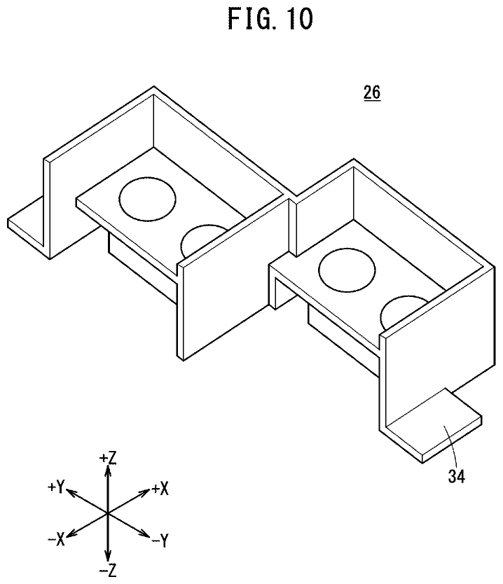

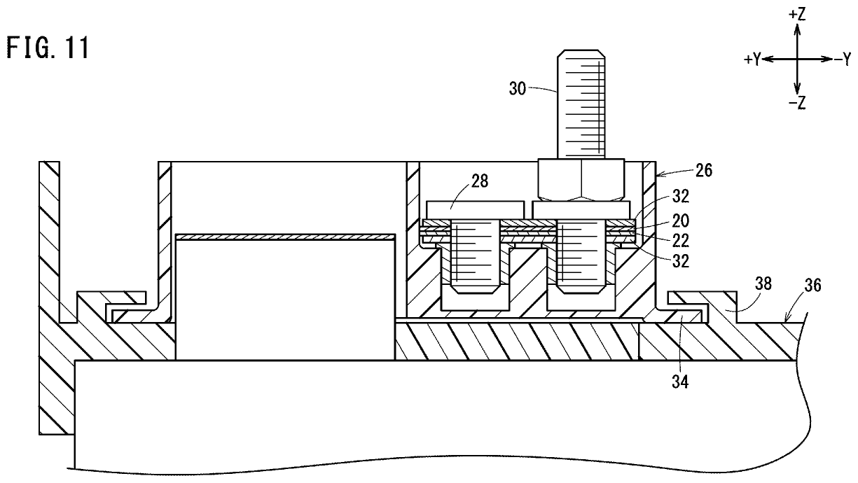

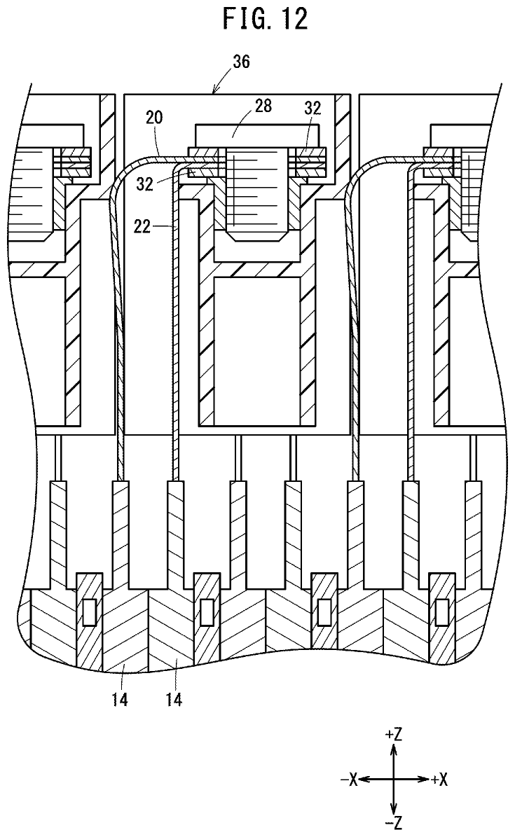

FIG. 9 is an enlarged perspective view of the connection portion between the positive electrode tab 20 and the negative electrode tab 22. FIG. 10 is a perspective view of a terminal block 26. FIGS. 11 and 12 are cross-sectional views of the connection portion of the positive electrode tab 20 and the negative electrode tab 22. FIG. 11 is a cross-sectional view taken in the X direction, and FIG. 12 is a cross-sectional view taken in the Y direction.

As shown in FIGS. 9, 11, and 12, the positive electrode tab 20 and the negative electrode tab 22 are fixed to the terminal block 26 by a first bolt 28 and a second bolt 30 in a state of being sandwiched between two tab plates 32. A battery management device (not shown) is connected to the second bolt 30. The battery management device monitors the inter-cell voltage of the battery cells 14 adjacent to each other and the temperature of the battery cells 14, and controls the charging and discharging of the battery module 12.

As shown in FIG. 10, the terminal block 26 has an engagement portion 34. As shown in FIG. 11, the engagement portion 34 engages with a guide groove 38 of a terminal plate 36. The terminal plate 36 positions the terminal block 26.

### Advantageous Effects

In the case of the battery device 10 of the present embodiment, the first tab connection portion 24a and the second tab connection portion 24b are adjacent to each other in the Y direction. At the first tab connection portion 24a, the positive electrode tab 20 provided to the first battery cell 14a and the negative electrode tab 22 provided to the second battery cell 14b are connected to each other. At the second tab connection portion 24b, the positive electrode tab 20 provided to the third battery cell 14c and the negative electrode tab 22 provided to the fourth battery cell 14d are connected to each other. Therefore, the distance can be narrowed between the first battery cell 14a, the second battery cell 14b, the third battery cell 14c, and the fourth battery cell 14d while the length of the first tab connection portion 24a and the second tab connection portion 24b in the X direction is made longer than the diameter of the first bolt 28 and the second bolt 30. As a result, the length of the battery module 12 can be reduced, and the battery device 10 can be miniaturized.

In respect of the battery device 10 of the present embodiment, the second tab connection portion 24b and the third tab connection portion 24c are adjacent to each other in the Y direction, and the first tab connection portion 24a and the third tab connection portion 24c are adjacent to each other in the X direction at the battery module 12. At the third tab connection portion 24c, the positive electrode tab 20 of the fifth battery cell 14e and the negative electrode tab 22 of the sixth battery cell 14f are connected to each other. Therefore, the distance can be narrowed between the first battery cell 14a, the second battery cell 14b, the third battery cell 14c, the fourth battery cell 14d, the fifth battery cell 14e, and the sixth battery cell 14f while the length of the first tab connection portion 24a and the second tab connection portion 24b in the X direction is made longer than the diameter of the first bolt 28 and the second bolt 30.

In the case of the battery device 10 of this embodiment, both the positive electrode tab 20 and the negative electrode tab 22 of the battery cell 14 are bent in the +X direction. Thereby, the tab connection portion between the positive electrode tab 20 of one battery cell 14 and the negative electrode tab 22 of another battery cell 14 adjacent to the one battery cell 14 in the +X direction is located farther in the +X direction than an intermediate portion between the one battery cell 14 and the other battery cell 14. Therefore, the distance between one battery cell 14 and the other battery cell 14 can be narrowed while the length of the tab connection portion is secured in the X direction.

In the case of the battery device 10 of this embodiment, the positive electrode tab 20 of one battery cell 14 and the negative electrode tab 22 of another battery cell 14 are fastened together using two bolts, i.e., the first bolt 28 and the second bolt 30. As a result, the diameters of two bolts when the contact pressure between the positive electrode tab 20 and the negative electrode tab 22 is secured by the two bolts can be made smaller than the diameter of a single bolt when the contact pressure is secured by the single bolt. Furthermore, as shown in FIG. 9, because the first bolt 28 and the second bolt 30 are arranged in the Y direction, the X-direction length of the tab connection portion between the positive electrode tab 20 and the negative electrode tab 22 can be shortened.

In the case of the battery device 10 of this embodiment, out of the first bolt 28 and the second bolt 30 that fasten the positive electrode tab 20 of one battery cell 14 and the negative electrode tab 22 of another battery cell 14, the second bolt 30 is connected to the battery management device. Thus, the second bolt 30 can serve both as a fastening member for fastening the positive electrode tab 20 and the negative electrode tab 22 and as a transmission member for transmitting the physical quantity of the battery cell 14.

In the case of the battery device 10 of this embodiment, the positive electrode tab 20 of one battery cell 14 and the negative electrode tab 22 of another battery cell 14 are fixed to the terminal block 26 by the first bolt 28 and the second bolt 30. This allows the positive electrode tab 20 and the negative electrode tab 22 to be firmly connected.

In the case of the battery device 10 of the present embodiment, the terminal block 26 includes the engagement portion 34 that engages with the guide groove 38 of the terminal plate 36. This allows positioning of the terminal block 26 with respect to the terminal plate 36.

### Inventions Obtained from Embodiment

The inventions that can be understood from the above embodiments are described below.

A battery device (10) comprising a plurality of battery cells (14) stacked in a first direction; a first tab connection portion (24a) connecting a first electrode tab (20) and a second electrode tab (22) with each other, the first electrode tab being provided for a first battery cell (14a) among the plurality of battery cells and the second electrode tab being provided for a second battery cell (14b) adjacent to the first battery cell among the plurality of battery cells; and a second tab connection portion (24b) connecting a third electrode tab (20) and a fourth electrode tab (22) with each other, the third electrode tab being provided for a third battery cell (14c) adjacent to the second battery cell among the plurality of battery cells and the fourth electrode tab (22) being provided for a fourth battery cell (14d) adjacent to the third battery cell (14c) among the plurality of battery cells wherein the first connection portion and the second connection portion are adjacent to each other in a second direction intersecting the first direction. As a result, intervals between battery cells can be narrowed.

The battery device may further include a third tab connection portion (24c) connecting a fifth electrode tab (20) and a sixth electrode tab (22), the fifth electrode tab being provided for a fifth battery cell (14e) adjacent to the fourth battery cell (14d) and the sixth electrode tab being provided for a sixth battery cell (14f) adjacent to the fifth battery cell, wherein the second tab connection portion and the third tab connection portion are adjacent to each other in the second direction, and the first tab connection portion and the third tab connection portion are arranged in the first direction. As a result, intervals between battery cells can be narrowed.

In respect of the battery device described above, the first electrode tab, the second electrode tab, the third electrode tab, and the fourth electrode tab may be bent toward one side in the first direction. As a result, intervals between battery cells can be narrowed.

In respect of the battery device described above, the first electrode tab, the second electrode tab, the third electrode tab, the fourth electrode tab, the fifth electrode tab, and the sixth electrode tab may be bent toward one side in the first direction. As a result, intervals between battery cells can be narrowed.

In respect of the battery device described above, at the first tab connection portion, the first electrode tab and the second electrode tab may be fastened to each other by using a plurality of fastening members (28, 30). This allows the length of the tab connection portion between the first electrode tab and the second electrode tab in the first direction to be reduced.

In respect of the battery device described above, one of the plurality of fastening members used to tighten the first electrode tab and the second electrode tab to each other may be connected to a battery management device. Thus, one fastening member can function as both a fastening member for fastening the first electrode tab and the second electrode tab and a transmission member for transmitting the physical quantity of the battery cell.

The battery device may further include a terminal block (26), and the first electrode tab and the second electrode tab may be fixed to the terminal block by the fastening member. This allows the first and second electrode tabs to be firmly connected.

The battery device may further include a terminal plate (36), and the terminal block may include an engagement portion (34) that engages with the terminal plate. This allows the terminal block to be positioned relative to the terminal plate.

The present invention is not limited to the above disclosure, and various configurations can be employed without departing from the gist of the present invention.

In the above embodiment, an example has been described in which the connection portion s of the positive electrode tab 20 and the negative electrode tab 22 are arranged in two rows in the X direction on one side of the center line L, and the connection portion s of the positive electrode tab 20 and the negative electrode tab 22 are arranged in two rows in the X direction on the other side of the center line L, but the present invention is not limited to this example. Three or more rows of connection portion s between the positive electrode tab 20 and the negative electrode tab 22 may be arranged in the X direction on one side of the center line L, and three or more rows of connection portion s between the positive electrode tab 20 and the negative electrode tab 22 may be arranged in the X direction on the other side of the center line L.

1. A battery device comprising:
a plurality of battery cells stacked in a first direction;
a first tab connection portion connecting a first electrode tab and a second electrode tab with each other, the first electrode tab being provided for a first battery cell among the plurality of battery cells and the second electrode tab being provided for a second battery cell adjacent to the first battery cell among the plurality of battery cells; and
a second tab connection portion connecting a third electrode tab and a fourth electrode tab with each other, the third electrode tab being provided for a third battery cell adjacent to the second battery cell among the plurality of battery cells and the fourth electrode tab being provided for a fourth battery cell adjacent to the third battery cell among the plurality of battery cells,
wherein the first tab connection portion and the second tab connection portion are adjacent to each other in a second direction intersecting the first direction.

2. The battery device according to claim 1, further comprising
a third tab connection portion connecting a fifth electrode tab and a sixth electrode tab, the fifth electrode tab being provided for a fifth battery cell adjacent to the fourth battery cell and the sixth electrode tab being provided for a sixth battery cell adjacent to the fifth battery cell,
wherein
the second tab connection portion and the third tab connection portion are adjacent to each other in the second direction, and
the first tab connection portion and the third tab connection portion are arranged in the first direction.

3. The battery device according to claim 1,
wherein the first electrode tab, the second electrode tab, the third electrode tab, and the fourth electrode tab are bent toward one side in the first direction.

4. The battery device according to claim 2,
wherein the first electrode tab, the second electrode tab, the third electrode tab, the fourth electrode tab, the fifth electrode tab, and the sixth electrode tab are bent toward one side in the first direction.

5. The battery device according to claim 1,
wherein at the first tab connection portion, the first electrode tab and the second electrode tab are fastened to each other by using a plurality of fastening members.

6. The battery device according to claim 5,
wherein one of the plurality of fastening members used to fasten the first electrode tab and the second electrode tab to each other is connected to a battery management device.

7. The battery device according to claim 5, further comprising a terminal block,
wherein the first electrode tab and the second electrode tab are fixed to the terminal block by the fastening members.

8. The battery device according to claim 7, further comprising a terminal plate,
wherein the terminal block includes an engagement portion that engages with the terminal plate.
